(19) United States
(12) Patent Application Publication
(10) Pub. No.: US 2009/0244822 A1
(43) Pub. Date: Oct. 1, 2009

(54) Touch control pen for a portable electronic device

(75) Inventors: Li-Ying Chen, Keelung City (TW); En-Guang Huang, Changhua County (TW); Jen-Yu Lee, Nantou County (TW); Fei-Ming Su, Changhua Hsien (TW)

Correspondence Address: Haynes and Boone, LLP;IP Section, 2323 Victory Avenue, SUITE 700, Dallas, TX, 75219, US

(73) Assignee: UNIVERSAL SCIENTIFIC INDUSTRIAL CO., LTD.

(21) Appl. No.: 12/079,829

(22) Filed: Mar. 28, 2008

(51) Int. Cl. G06F 1/16

(52) U.S. Cl. 361/679.02

(57) ABSTRACT

A touch control pen for a portable electronic device includes a resilient positioning sleeve sleeved sealingly on an elongate main body and disposed adjacent to a head end of the main body. When the touch control pen is inserted into a slot defined by a looped surrounding wall of a housing of the portable electronic device, the positioning sleeve contacts watertightly an inner annular surface of the looped surrounding wall of the housing.

### BACKGROUND OF THE INVENTION

1. Field of the Invention

The invention relates to a touch control pen for a portable electronic device, more particularly to a touch control pen for a portable electronic device that can be assembled watertightly to the portable electronic device.

2. Description of the Related Art

Referring to FIGS. 1 to 3, a conventional portable electronic device 1 is shown to include a housing 11, and a touch control pen 12.

The housing 11 consists of complementary first and second housing parts 111, 112. The second housing part 112 is formed with an elongate slot 110 that is defined by a base wall 113, opposite inner lateral walls 34 and an inner cover plate 115 of the second housing part 112. The inner cover plate 115 is formed with au-shaped groove 116 defining a resilient member 118. The resilient member 118 has a hook-shaped free end 1181 extending into the slot 110 in the second housing part 112 (see FIG. 3). A plastic film 117 is attached to the inner cover plate 117 for covering sealingly the U-shaped groove 116, thereby preventing water from permeating into the housing 11 through the U-shaped groove 116.

The touch control pen 12 includes a main body 121 that has a tip end 1211, a head end 1212 opposite to the tip end 1211, and an outer annular surface formed with an annular engaging groove 124 disposed adjacent to the tip end 1211. When the touch control pen 12 is inserted into the slot 110 in the second housing part 112 of the housing 11, the head end 1212 of the main body 121 is disposed outwardly of the second housing part 112, and the hook-shaped free end 1181 of the resilient member 118 engages detachably the annular engaging groove 124, thereby positioning the touch control pen 12 in the slot 110.

However, in order to prevent water from permeating into the housing 11, it is required to connect sealingly the inner cover plate 115 to the inner lateral walls 114 and to cover sealingly the U-shaped groove 116 in the inner cover plate 115 by means of the plastic film. As a result, the housing 11 is manufactured in a relatively complicated process. In addition, since engagement between the annular engaging groove 124 in the main body 121 of the touch control pen 12 and the hook-shaped free end 1181 of the resilient member 118 cannot be ensured as a result of resilience fatigue of the resilient member 118 after a period of use, the touch control pen 12 cannot be securely positioned in the slot 110 in the second housing part 112 of the housing 11.

### SUMMARY OF THE INVENTION

Therefore, the object of the present invention is to provide a touch control pen for a portable electronic device that can be assembled watertightly to the portable electronic device.

According to the present invention, a touch control pen is adapted for use with a portable electronic device. The portable electronic device includes a housing formed with an elongate slot that is defined by a looped surrounding wall. The looped surrounding wall has an inner annular surface. The touch control pen comprises:

an elongate main body having a tip end adapted to be disposed in the slot in the housing of the portable electronic device, and a head end opposite to the tip end and adapted to be disposed outwardly of the housing of the portable electronic device; and

a resilient positioning sleeve sleeved sealingly on the main body and disposed adjacent to the head end of the main body.

The positioning sleeve contacts watertightly the inner annular surface of the looped surrounding wall of the housing of the portable electronic device when the touch control pen is inserted into the slot in the housing of the portable electronic device.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a conventional portable electronic device;

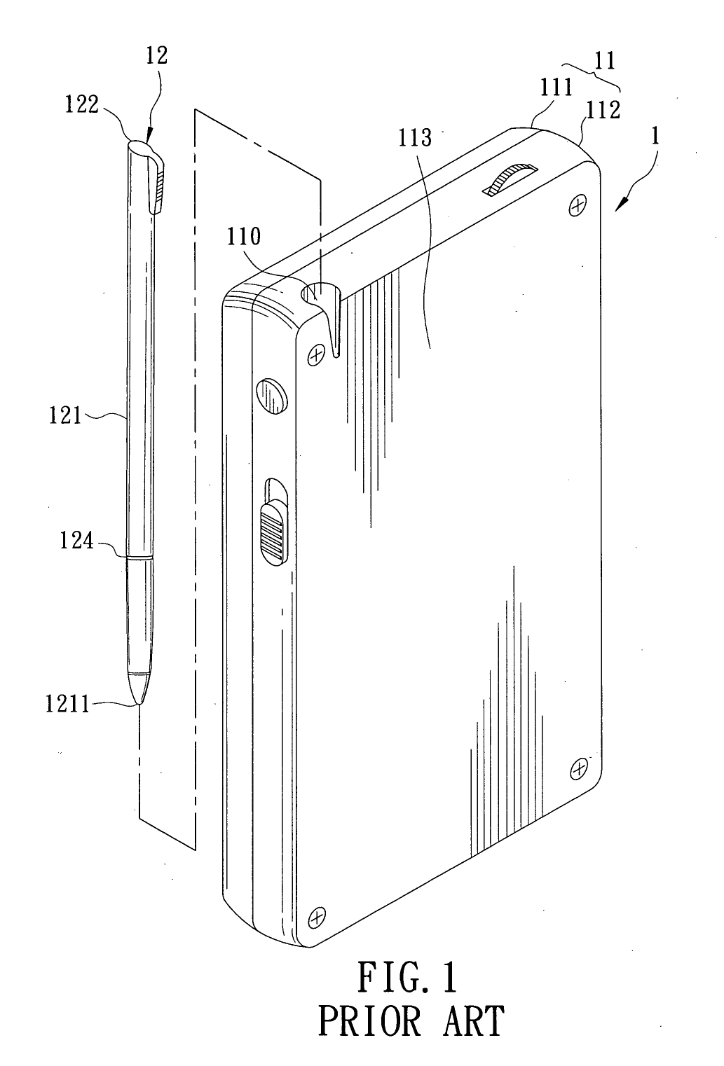

FIG. 2 is a fragmentary assembled perspective view of the conventional portable electronic device;

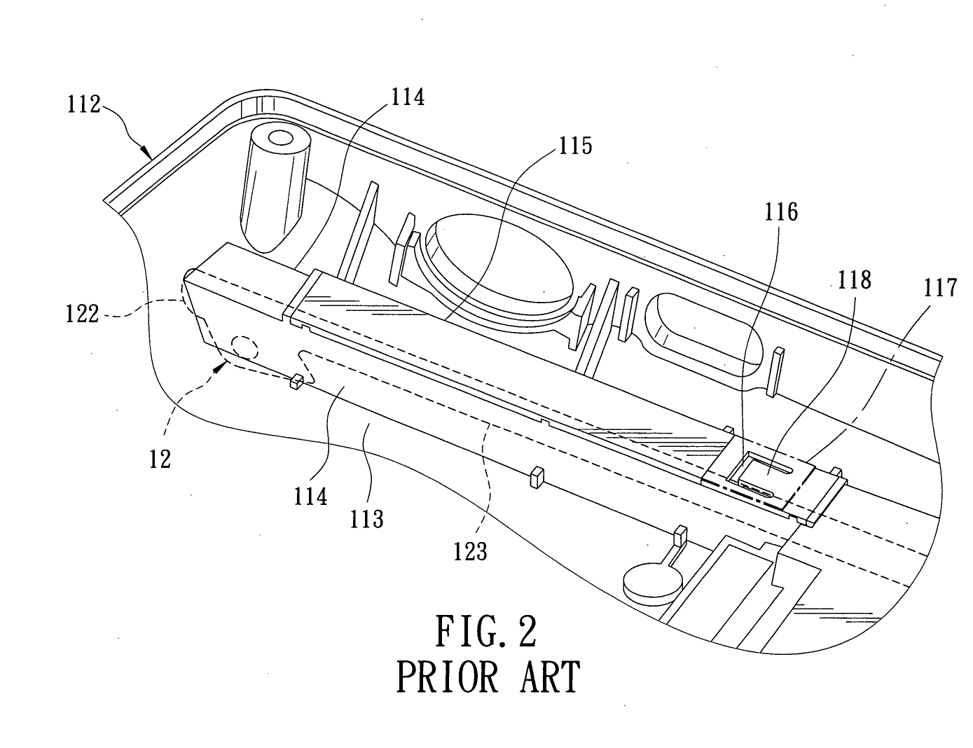

FIG. 3 is a fragmentary assembled schematic sectional view of the conventional portable electronic device;

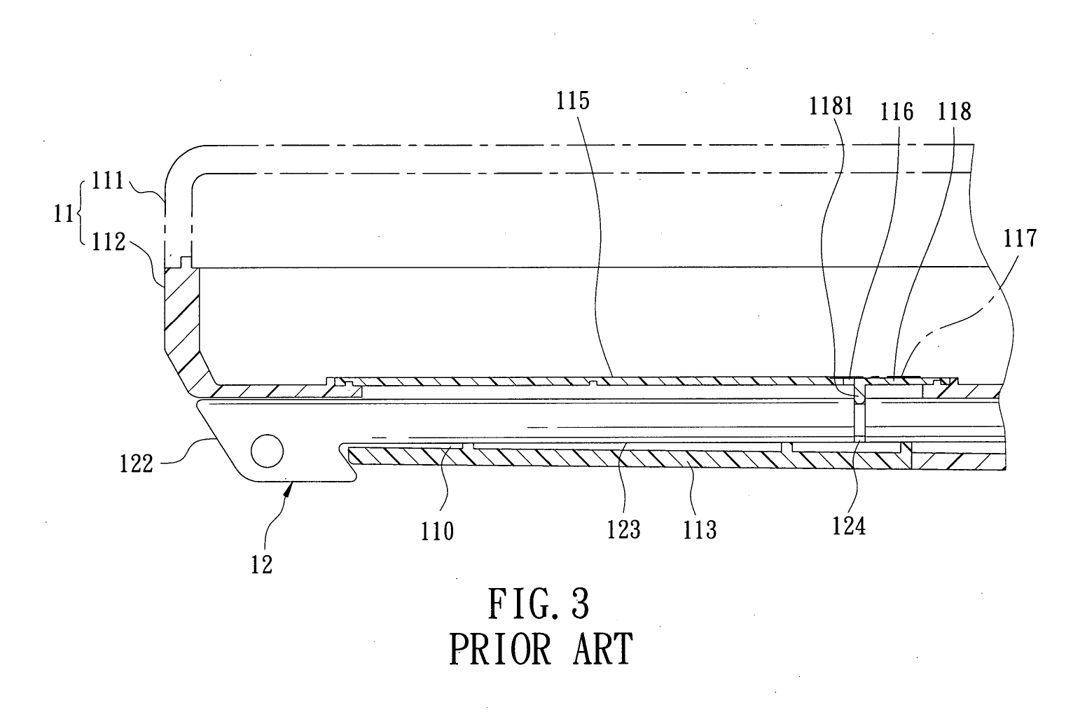

FIG. 4 is a perspective view showing the preferred embodiment of a touch control pen according to the present invention;

FIG. 5 is a fragmentary perspective view showing an assembly of the preferred embodiment and a housing part of a portable electronic device;

FIG. 6 is a fragmentary schematic sectional view showing the assembly of the preferred embodiment and the housing part of the portable electronic device; and

FIG. 7 is a fragmentary schematic sectional view of the assembly of the preferred embodiment and the housing part taken along line VII-VII in FIG. 5.

### DETAILED DESCRIPTION OF THE PREFERRED EMBODIMENT

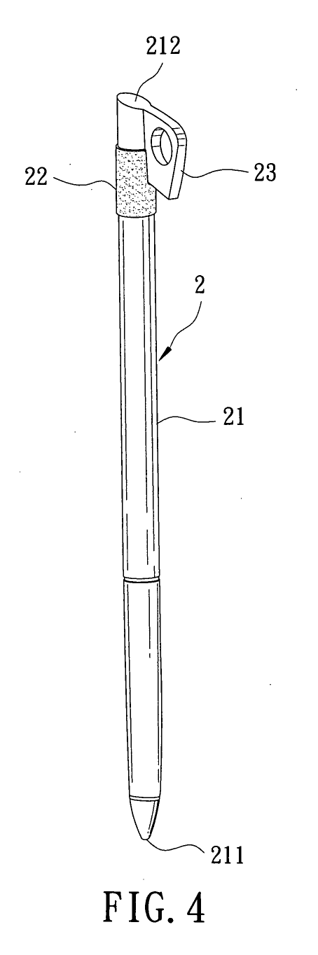

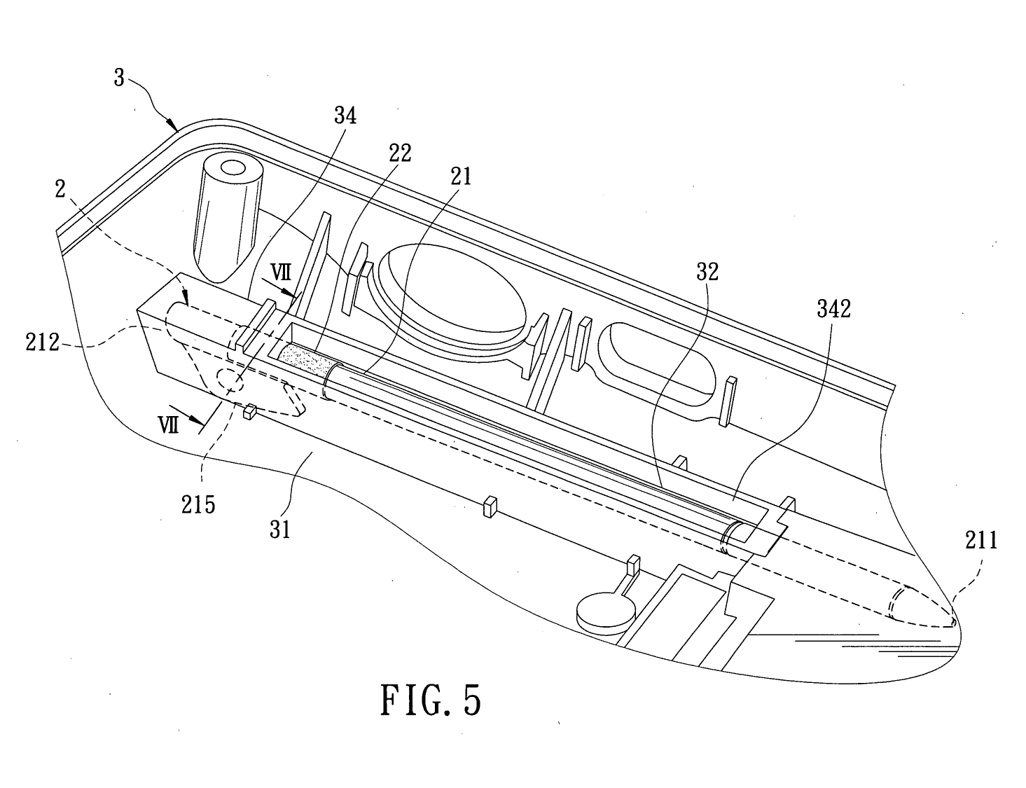

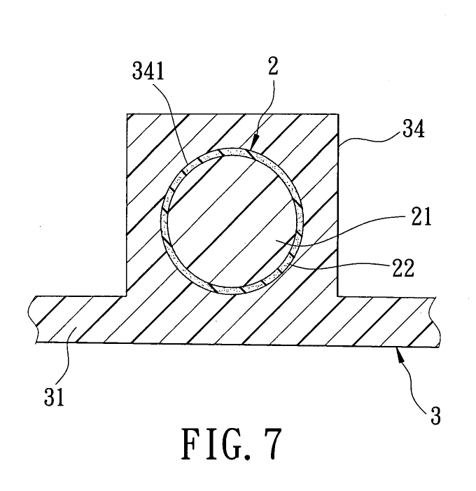

Referring to FIGS. 4 to 6, the preferred embodiment of a touch control pen 2 according to the present invention is shown to be adapted for use with a portable electronic device. In this embodiment, the portable electronic device includes a housing that consists of complementary upper and lower housing parts 3 (only the lower housing part 3 is shown in FIG. 5). The lower housing part 3 of the housing is formed with an elongate slot 32 that is defined by a looped surrounding wall 34. As shown in FIG. 7, the looped surrounding wall 34 has an inner annular surface 341, and has a lower portion connected integrally to a base wall 31 of the lower housing part 3. The touch control pen 2 includes an elongate main body 21, and a resilient positioning sleeve 22.

The main body 21 has a tip end 211 adapted to be disposed in the slot 32 in the lower housing part 3 of the housing, and a head end opposite to the tip end 211 and adapted to be disposed outwardly of the lower housing part 3 of the housing. In this embodiment, the main body 21 is made of plastic, and is formed by molding.

The resilient positioning sleeve 22 is sleeved sealingly on the main body 21 and disposed adjacent to the head end 212 of the main body 21. In this embodiment, the resilient positioning sleeve 22 is made of rubber, and is injection-molded on the main body 21. It is noted that the positioning sleeve 22 has an outer diameter that is slightly larger than a diameter of the slot 32 in the lower housing part 3 of the housing. As a result, when the touch control pen 2 is inserted forcedly into the slot 32 in the lower housing part 3 of the housing, the positioning sleeve 22 contacts watertightly the inner annular surface 341 of the looped surrounding wall 34 of the lower housing part 3 of the housing (see FIG. 7), thereby positioning the touch control pen 2 in the slot 32 in the lower housing 3 of the housing due to friction between the inner annular surface 341 of the looped surrounding wall 34 and the positioning sleeve 22.

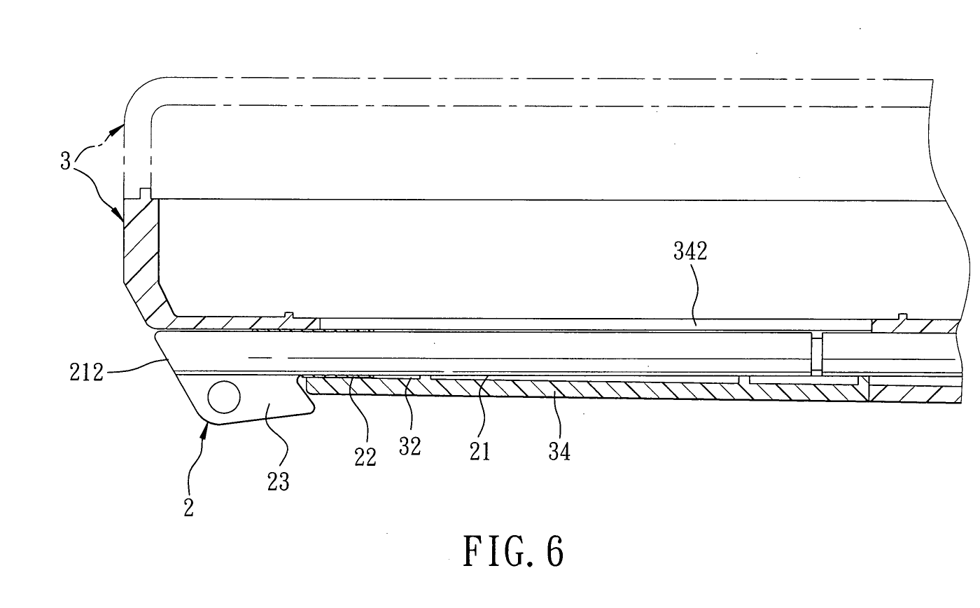

In this embodiment, the touch control pen 2 further includes a position-limiting projection 23 extending laterally and integrally from the main body 21 and disposed between the head end 212 of the main body 21 and the positioning sleeve 22, and adapted to be disposed outwardly of the lower housing part 3 of the housing, as shown in FIG. 6.

In sum, due to the presence of the resilient positioning sleeve 22, the touch control pen 2 is assembled watertightly to the housing of the portable electronic device when the touch control pen 2 is inserted into the slot 32 in the lower housing part 3 of the housing, thereby effectively preventing water from permeating into the housing without the need for an additional cover plate or plastic film as used in the prior art for covering an opening 342 in the looped surrounding wall 34 (see FIGS. 5 and 6). Therefore, the touch control pen 2 of this invention is adapted for use with the portable electronic device having the housing that can be easily manufactured at a relatively low cost.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A touch control pen for a portable electronic device, the portable electronic device including a housing formed with an elongate slot that is defined by a looped surrounding wall, the looped surrounding wall having an inner annular surface, said touch control pen comprising:
an elongate main body having a tip end adapted to be disposed in the slot in the housing of the portable electronic device, and a head end opposite to said tip end and adapted to be disposed outwardly of the housing of the portable electronic device; and
a resilient positioning sleeve sleeved sealingly on said main body and disposed adjacent to said head end of said main body;
wherein said positioning sleeve contacts watertightly the inner annular surface of the looped surrounding wall of the housing of the portable electronic device when said touch control pen is inserted into the slot in the housing of the portable electronic device.

2. The touch control pen as claimed in claim 1, wherein said positioning sleeve has an outer diameter that is slightly larger than a diameter of the slot in said housing of the portable electronic device.

3. The touch control pen as claimed in claim 1, further comprising a position-limiting projection extending laterally and integrally from said main body and disposed between said head end of said main body and said positioning sleeve, and adapted to be disposed outwardly of the housing of the portable electronic device.

4. The touch control pen as claimed in claim 1, wherein said main body and said positioning sleeve are made of plaster and rubber, respectively, said positioning sleeve being injection-molded on said main body.

5. The touch control pen as claimed in claim 4, wherein said main body is formed by molding.
